(19) United States
(12) Patent Application Publication
(10) Pub. No.: US 2026/0328936 A1
(43) Pub. Date: Oct. 22, 2026

(54) RADAR SENSOR AND METHOD OF OPERATING THE SAME

(71) Applicant: RichWave Technology Corp., Taipei City (TW)

(72) Inventor: Shun-Pin Yang, Taipei City (TW)

(73) Assignee: RichWave Technology Corp., Taipei City (TW)

(21) Appl. No.: 19/550,302

(22) Filed: Feb. 26, 2026

Related U.S. Application Data
(60) Provisional application No. 63/789,448, filed on Apr. 16, 2025.

(30) Foreign Application Priority Data
Dec. 31, 2025 (TW) 114152226

(51) Int. Cl. G01S 13/931

(52) U.S. Cl. CPC G01S 13/931; G01S 2013/9314

(57) ABSTRACT

A method of operating a radar sensor includes obtaining a first radar signature at a first time point, and, in response to a storage command, storing the first radar signature as a no-vehicle reference signature, wherein the no-vehicle reference signature includes features of a fixed obstacle within a parking space. The method further includes obtaining a second radar signature at a second time point, comparing the second radar signature with the no-vehicle reference signature to determine a first similarity, and processing the second radar signature based on the first similarity.

### CROSS REFERENCE TO RELATED APPLICATION

This application claims the benefit of U.S. Provisional Application No. 63/789,448, filed on Apr. 16th, 2025, and claims priority to Taiwan Patent Application No. 114152226, filed on Dec. 31st, 2025. The content of the applications are incorporated herein by reference.

### TECHNICAL FIELD

The present invention relates to electronic circuits, and more particularly to a radar sensor suitable for parking management and a method thereof.

### BACKGROUND

With rapid urbanization and increasing vehicle numbers, parking management has become an important urban transportation issue. Traditional parking management relies on manual patrols or ticketing personnel, which not only incurs high labor costs but also makes it difficult to provide real-time and accurate parking information. To address this problem, smart parking systems have emerged, automatically monitoring parking space status through sensing technology, reducing manpower requirements and improving management efficiency.

Conventional parking space sensing technologies mainly include geomagnetic sensors, ultrasonic sensors, and cameras. Geomagnetic sensors are embedded in the center of parking spaces and determine parking status by detecting the influence of vehicle chassis metal on magnetic fields, but they are susceptible to interference from external magnetic fields such as power lines, and their sensing effectiveness is poor for high-clearance vehicles or specific parking positions. Ultrasonic sensors detect object presence through ranging principles, but their ranging accuracy is easily affected by temperature changes, and the low-frequency acoustic characteristics limit their environmental adaptability. Cameras combined with image recognition technology can provide intuitive monitoring effects, but they consume significant power and require continuous computational processing, which is disadvantageous for long-term deployment applications.

In recent years, radar sensing technology has gradually been applied to parking monitoring, offering advantages such as resistance to temperature and magnetic field interference, and low power consumption. However, existing radar parking sensing technologies still face important challenges: fixed obstacles within parking spaces (such as manhole covers, electrical equipment boxes, etc.) are easily misidentified as vehicles; moving objects such as pedestrians and animals passing by cause false alarms; environmental temperature changes affect radar circuit characteristics, leading to reduced judgment accuracy. Additionally, while multi-antenna radar arrays can provide two-dimensional coordinate positioning capabilities, they are costly and have high system complexity, which is disadvantageous for large-scale deployment. Therefore, there is a need for a parking management solution that can effectively eliminate misjudgment of fixed obstacles, filter interference from moving objects, adapt to temperature changes, and is cost-effective.

### SUMMARY

An embodiment provides a method of operating a radar sensor. The method includes obtaining a first radar signature at a first time point and, in response to a storage command, storing the first radar signature as a no-vehicle reference signature, wherein the no-vehicle reference signature includes features of fixed obstacles within a parking space. The method further includes obtaining a second radar signature at a second time point, comparing the second radar signature with the no-vehicle reference signature to determine a similarity, and processing the second radar signature based on the similarity.

An embodiment provides a radar sensor including an antenna and a processing circuit. The antenna is configured to receive an echo signal. The processing circuit is coupled to the antenna and is configured to obtain a first radar signature based on the echo signal at a first time point, in response to a storage command, store the first radar signature as a no-vehicle reference signature, wherein the no-vehicle reference signature includes features of fixed obstacles within a parking space, obtain a second radar signature based on the echo signal at a second time point, compare the second radar signature with the no-vehicle reference signature to determine a similarity, and process the second radar signature based on the similarity.

### BRIEF DESCRIPTION OF THE DRAWINGS

FIG. 1 is a schematic diagram of a parking system according to an embodiment of the present invention.

FIG. 2 is a flowchart of a method of operating the radar sensor of FIG. 1.

FIG. 3 is a flowchart of an object presence process in FIG. 2.

FIG. 4 is a flowchart of another object presence process in FIG. 2.

FIG. 5 is a flowchart of a parking confirmation process in FIG. 2.

FIG. 6 is a flowchart of another parking confirmation process in FIG. 2.

FIG. 7 is a flowchart of a vehicle departure process in FIG. 2.

FIG. 8 is a flowchart of another vehicle departure process in FIG. 2.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

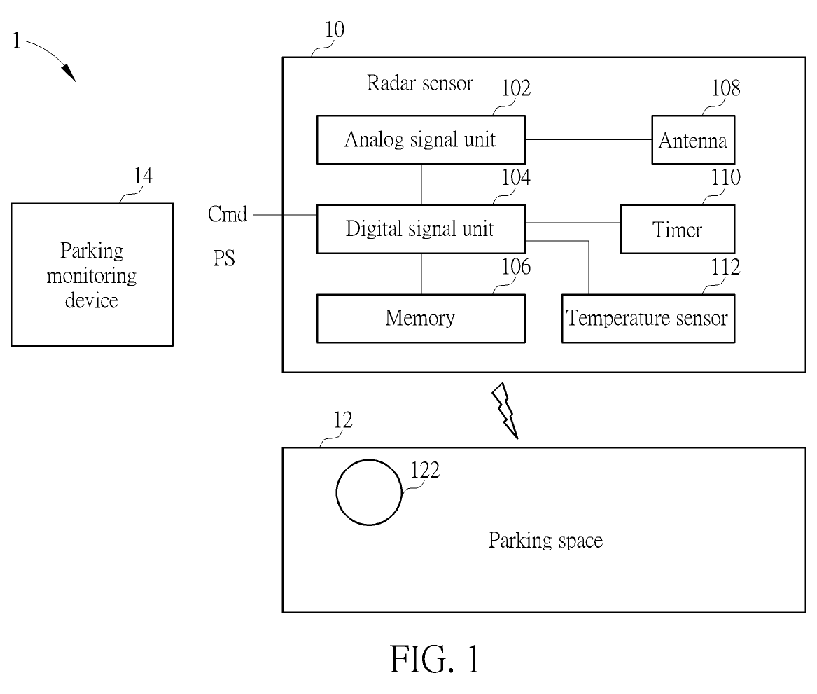

FIG. 1 is a schematic diagram of a parking system 1 according to an embodiment of the present invention. The parking system 1 includes a radar sensor 10 and a parking monitoring device 14, configured to provide parking management functions. The parking space 12 may be a parking spot, and the radar sensor 10 may be installed on a fixed pole or other fixed object beside the parking space 12 for monitoring the vehicle parking status within the parking space 12. The parking monitoring device 14 may be coupled to the radar sensor 10 for obtaining parking space status information and executing corresponding parking management functions.

The parking system 1 may be applicable to roadside parking spots, parking lots, or other locations requiring monitoring of vehicle parking status. The radar sensor 10 detects the presence of objects within the parking space 12 by transmitting radio frequency signals and receiving reflected echo signals. Compared with traditional geomagnetic sensors or ultrasonic sensors, the radar sensor 10 has better environmental adaptability and is not easily affected by magnetic field interference or temperature changes. The parking monitoring device 14 may be a central monitoring system, edge computing device, or cloud server for integrating monitoring data from multiple parking spaces and providing intelligent parking management services such as real-time parking information inquiry, automatic billing, and violation detection.

The parking system 1 can provide solutions for misjudgment problems caused by fixed obstacles and moving obstacles. The parking space 12 includes fixed obstacles 122, such as manhole covers, electrical equipment boxes, fire hydrants, or other infrastructure, and may also have moving obstacles such as pedestrians or animals. In traditional parking systems, fixed obstacles or moving obstacles are easily misidentified as parked vehicles, affecting the accuracy of parking judgment. Through a no-vehicle reference signature establishment mechanism, the parking system 1 can incorporate the features of fixed obstacles 122 into a background reference during installation or maintenance, thereby eliminating misjudgment caused by fixed obstacles and improving the reliability and accuracy of parking status detection. Additionally, because the signal features of moving obstacles are unstable, the parking system 1 can record the signal features of suspected objects and only determine vehicle parking or departure when the signal features of the suspected objects maintain high similarity over a period of time, thereby avoiding misjudgment caused by moving obstacles and improving the accuracy and reliability of the parking system 1.

The radar sensor 10 may include an analog signal unit 102, a digital signal unit 104, a memory 106, an antenna 108, a timer 110, and a temperature sensor 112. The antenna 108 may be coupled to the analog signal unit 102. The analog signal unit 102, the timer 110, and the temperature sensor 112 may be coupled to the digital signal unit 104. The digital signal unit 104 may be coupled to the memory 106 and the parking monitoring device 14. The radar sensor 10 may be, but is not limited to, a frequency modulated continuous wave (FMCW) radar.

The antenna 108 may transmit radio frequency signals and obtain echo signals reflected by objects within the parking space 12. The antenna 108 may adopt a single-antenna design to implement monitoring functions of the parking space 12 through one-dimensional distance detection. The analog signal unit 102 may perform analog signal functions including signal transmission and reception, power amplification, signal modulation, filtering, and other analog circuit functions. The digital signal unit 104 may perform digital signal functions including fast Fourier transform (FFT), radar signature extraction, feature matching analysis, similarity calculation, core algorithm processing, and other digital signal functions. The memory 106 may include volatile memory for temporarily storing data during real-time operations, and non-volatile memory (such as flash memory) for preserving data after power loss, such as radar signature data.

The timer 110 may provide a periodic wake-up function to control the radar sensor 10 to enter sleep mode to achieve power-saving effects. The timer 110 may also provide a time reference to support functions for periodically updating the no-vehicle reference signature and/or vehicle-present signature. The vehicle-present signature may include features of a parked vehicle in the parking space 12. The temperature sensor 112 is an optional component that may detect environmental temperature changes. When equipped with the temperature sensor 112, the parking system 1 can establish candidate temperature intervals based on temperature and select corresponding no-vehicle reference signatures for comparison, thereby improving judgment accuracy under different temperature environments.

If the radar sensor 10 receives a storage command Cmd when obtaining a radar signature at a time point, the digital signal unit 104 may, in response to the storage command Cmd, store the radar signature as a no-vehicle reference signature in the memory 106. The no-vehicle reference signature may include features of the fixed obstacle 122 in the parking space 12. Subsequently, the digital signal unit 104 may obtain subsequent radar signatures at other time points, compare the subsequent radar signatures with the no-vehicle reference signature to determine similarity, and process the subsequent radar signatures based on the similarity (such as discarding or storing). The storage command Cmd may come from the parking monitoring device 14 or from a wireless communication device (such as a mobile phone or laptop) near the radar sensor 10. For example, during installation, installation personnel can send the storage command Cmd to the radar sensor 10 through a laptop after confirming the no-vehicle status. Alternatively, during subsequent maintenance, personnel can send the storage command Cmd from the parking monitoring device 14 to the radar sensor 10 after confirming the no-vehicle status through a remote camera.

The radar sensor 10 may report the status PS of the parking space 12 to the parking monitoring device 14, where the status PS may be status information of "no vehicle," "object present" or "parking confirmed" for the parking monitoring device 14 to execute parking management functions.

The parking system 1 has automated monitoring capabilities to reduce manual intervention requirements, while extending equipment service life through power-saving design, suitable for intelligent management applications of roadside parking spots or parking lots.

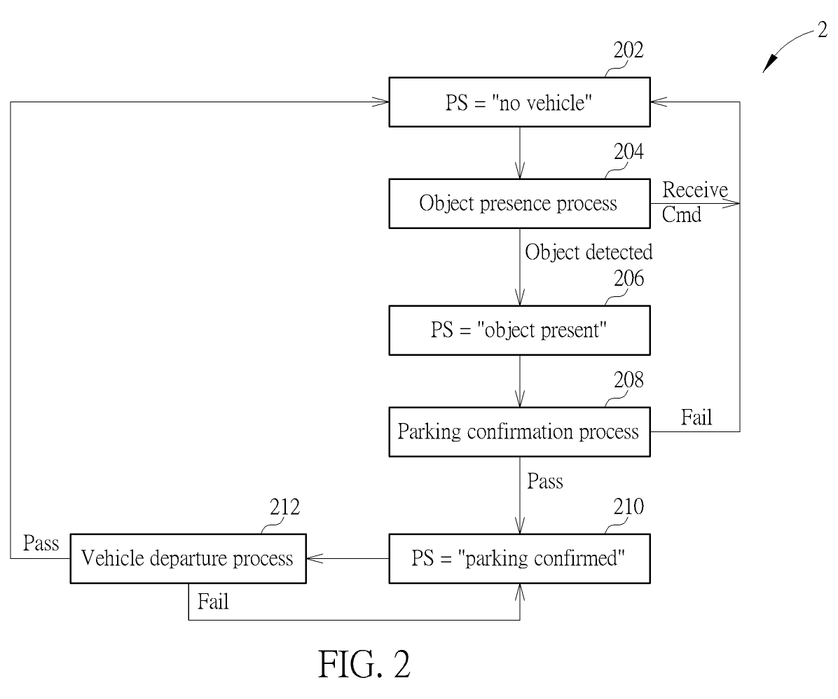

FIG. 2 is a flowchart of a method 2 of operating the radar sensor 10. The method 2 includes steps 202 to 212 for implementing intelligent monitoring and status management of the parking space 12. Any reasonable technical modifications or step adjustments fall within the scope disclosed by the present invention. The detailed contents of steps 202 to 212 are described as follows:

Step 202: Set the status PS of the parking space 12 to "no vehicle"; continue to step 204;

Step 204: Perform an object presence process; if the storage command Cmd is received, continue to step 202; if an object is detected, continue to step 206;

Step 206: Set the status PS of the parking space 12 to "object present"; continue to step 208;

Step 208: Perform a parking confirmation process; if confirmation passes, continue to step 210; if confirmation fails, return to step 202;

Step 210: Set the status PS of the parking space 12 to "parking confirmed"; continue to step 212;

Step 212: Perform a vehicle departure process; if confirmation passes, indicating the vehicle has departed, return to step 202; if confirmation fails, return to step 210 for re-confirmation.

Furthermore, in step 202, the initial status PS of the parking space 12 is "no vehicle," indicating that no vehicle is parked in the parking space 12.

Next, in step 204, when the status PS of the parking space 12 is "no vehicle," the radar sensor 10 performs an object presence process for updating the no-vehicle reference signature and monitoring whether an object has entered the parking space 12. If the storage command Cmd is received, the radar sensor 10 updates the no-vehicle reference signature and sets and reports the status PS of the parking space 12 as "no vehicle" (step 202). If an object is detected, the radar sensor 10 sets the status PS of the parking space 12 to "object present" (step 206).

In step 208, when the status PS of the parking space 12 is "object present," the radar sensor 10 performs a parking confirmation process to confirm the vehicle parking status and exclude false triggers from moving objects. The radar sensor 10 may employ a vehicle-present confidence accumulation mechanism to filter out temporary interference caused by moving objects. If the vehicle-present confidence accumulation mechanism determines a pass, indicating that a vehicle has indeed parked in the parking space 12, the radar sensor 10 sets and reports the status PS of the parking space 12 as "parking confirmed" (step 210). If the vehicle-present confidence accumulation mechanism determines a failure, indicating that a false trigger from a moving object has been identified, the radar sensor 10 sets and reports the status PS of the parking space 12 as "no vehicle" (step 202).

In step 212, when the status PS of the parking space 12 is "parking confirmed," the radar sensor 10 performs a vehicle departure process to determine whether the vehicle has actually departed from the parking space 12 and to exclude false triggers from moving objects. The radar sensor 10 may employ a no-vehicle confidence accumulation mechanism to filter out temporary interference caused by moving objects. If the no-vehicle confidence accumulation mechanism determines a pass, indicating that the vehicle has indeed departed from the parking space 12, the radar sensor 10 sets and reports the status PS of the parking space 12 as "no vehicle" (step 202). If the no-vehicle confidence accumulation mechanism determines a failure, indicating that a false trigger from a moving object has been identified, the radar sensor 10 sets the status PS of the parking space 12 to "parking confirmed" (step 210).

The method 2 employs an external storage command Cmd to establish a no-vehicle reference signature baseline for filtering fixed object interference, while employing multiple verification mechanisms through the object presence process of step 204, the parking confirmation process of step 208, and the vehicle departure process of step 212 to exclude moving object interference and reduce the false alarm rate. The parking system 1 has a status returning design and transient processing capability, and when a moving object is detected or a judgment error occurs, it can flexibly transition to an appropriate status, ensuring the accuracy of parking monitoring and stable system operation.

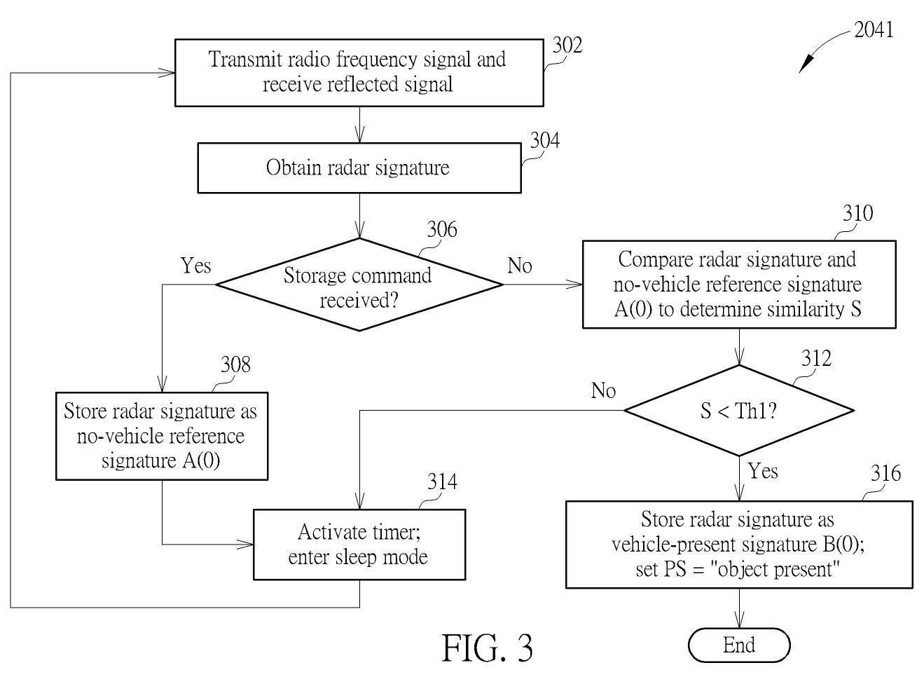

Detailed operation methods of the object presence process of step 204, the parking confirmation process of step 208, and the vehicle departure process of step 212 may refer to the embodiments of FIGS. 3-8, ensuring that the radar sensor 10 accurately and reliably performs the monitoring function of the parking space 12.

FIG. 3 is a flowchart of an object presence process 2041. The process 2041 is an embodiment of step 204 of FIG. 2. The process 2041 includes steps 302 to 316 for updating the no-vehicle reference signature according to a command and monitoring whether an object has entered the parking space 12. The object presence process 2041 of FIG. 3 is suitable for application scenarios where environmental temperature variation is relatively small. Any reasonable technical modifications or step adjustments fall within the scope disclosed by the present invention. The detailed contents of steps 302 to 316 are described as follows:

Step 302: The analog signal unit 102 and the antenna 108 transmit a radio frequency signal and receive a reflected signal;

Step 304: The digital signal unit 104 obtains a radar signature;

Step 306: The radar sensor 10 determines whether the storage command Cmd has been received? If yes, continue to step 308; if no, continue to step 310;

Step 308: The memory 106 stores the radar signature as a no-vehicle reference signature A(0); continue to step 314;

Step 310: The digital signal unit 104 compares the radar signature with the no-vehicle reference signature A(0) to determine a similarity S;

Step 312: The digital signal unit 104 determines whether the similarity S is less than a threshold Th1? If yes, continue to step 316; if no, continue to step 314;

Step 314: The radar sensor 10 activates the timer 110 and enters sleep mode; return to step 302;

Step 316: The memory 106 stores the radar signature as a vehicle-present signature B(0), and the radar sensor 10 sets and reports the status PS of the parking space 12 as "object present"; end the object presence process 2041.

Furthermore, in step 302, the analog signal unit 102 and the antenna 108 transmit a radio frequency signal to the parking space 12 and receive echo signals reflected from objects for obtaining object information within the parking space 12.

In step 304, the digital signal unit 104 processes the received echo signals and, through digital signal processing techniques such as fast Fourier transform (FFT), obtains a radar signature at the current time point, including information such as distance and intensity of all objects within the parking space 12. The radar signature may include frequency spectrum data, such as magnitudes of predetermined frequencies, peak frequency, and peak magnitude.

In step 306, the radar sensor 10 determines whether the storage command Cmd has been received. If the storage command Cmd is received, the digital signal unit 104 executes step 308 to establish a no-vehicle reference signature baseline; if the storage command Cmd is not received, the digital signal unit 104 executes step 310 to perform feature matching analysis.

In step 308, when the storage command Cmd is received, the digital signal unit 104 stores the currently obtained radar signature as the no-vehicle reference signature A(0) in the memory 106 as a baseline for subsequent comparison. The no-vehicle reference signature A(0) includes features of the fixed obstacle 122 in the parking space 12, such as a manhole cover or electrical equipment box. After storage is complete, the radar sensor 10 executes step 314 to enter sleep mode.

The radar sensor 10 compares whether the current radar signature and the no-vehicle reference signature A(0) are similar through steps 310 and 312. In step 310, the digital signal unit 104 compares the currently obtained radar signature with the previously stored no-vehicle reference signature A(0) to calculate a similarity S between the current radar signature and the no-vehicle reference signature A(0). In step 312, the digital signal unit 104 determines whether the similarity S is less than a first threshold Th1, thereby determining whether the current radar signature and the no-vehicle reference signature A(0) are similar. If the similarity S is less than the threshold Th1, indicating that the current radar signature is dissimilar to the no-vehicle reference signature A(0), an object may have entered the parking space 12, and the digital signal unit 104 executes step 316 to establish a vehicle-present signature B(0); if the similarity S is not less than the threshold Th1, that is, the similarity S is greater than or equal to the threshold Th1, indicating that the current radar signature is similar to the no-vehicle reference signature A(0), the digital signal unit 104 executes step 314 to maintain the monitoring status.

Comparison methods for the current radar signature and the no-vehicle reference signature A(0) may include a data error comparison method, a vector inner product analysis method, a frequency spectrum analysis method, and a combined comparison method.

For the data error comparison method, the digital signal unit 104 may perform point-by-point comparison of sampling points of the current radar signature and the no-vehicle reference signature A(0), calculate point-to-point errors, and accumulate the total error to generate the similarity S. When the similarity S is greater than or equal to the threshold Th1, it is determined as high similarity (empty parking space); when the similarity S is less than the preset threshold Th1, it is determined as low similarity (object occupying parking space).

For the vector inner product analysis method, the digital signal unit 104 may treat the sampling points as mathematical vectors, calculate the inner product of the current radar signature and the no-vehicle reference signature A(0) to determine the angle between the two vectors to generate the similarity S. When the similarity S is greater than or equal to the threshold Th1 (small angle), it indicates high similarity (empty parking space); when the similarity S is less than the preset threshold Th1 (large angle), it indicates low similarity (object occupying parking space).

For the frequency spectrum analysis method, the digital signal unit 104 may analyze frequency domain characteristics, comparing the signal peak magnitudes and frequencies of the current radar signature and the no-vehicle reference signature A(0). The similarity S is generated by comparing peak magnitudes and frequency offsets, using dual thresholds to evaluate peak magnitude and degree of frequency offset.

The combined comparison method is an advanced technique combining the data error comparison method and the frequency spectrum analysis method. First, features of the fixed obstacle 122 are identified in the no-vehicle reference signature A(0), that is, components in the no-vehicle reference signature A(0) that are greater than a preset value, and the features of the fixed obstacle 122 are defined as being located in a first frequency spectrum range. Then, for portions outside the first frequency spectrum range, the current radar signature is compared with the no-vehicle reference signature A(0) to determine the similarity S, thereby excluding the influence of the fixed obstacle 122 on the similarity calculation.

The radar sensor 10 processes the current radar signature through steps 314 and 316. In step 314, because the current radar signature is similar to the no-vehicle reference signature A(0), indicating that no vehicle is present in the parking space 12, the digital signal unit 104 discards the current radar signature, activates the timer 110, and enters sleep mode to achieve power-saving purposes. The timer 110 will wake up the system after a preset time and return to step 302 to continue the monitoring cycle.

In step 316, because the current radar signature is dissimilar to the no-vehicle reference signature A(0), indicating that the parking space 12 is occupied by an object, the digital signal unit 104 stores the current radar signature as a vehicle-present signature B(0) in the memory 106 and sets the status PS of the parking space 12 to "object present." The status PS of "object present" indicates that an object has been detected in the parking space 12, and it has not yet been confirmed that the object in the parking space 12 is a parked vehicle. After step 316, the object presence process 2041 ends, and the radar sensor 10 will transition to the status PS of "object present" in step 206 of FIG. 2.

The object presence process 2041 in FIG. 3 uses an external storage command to establish a no-vehicle reference signature, then employs comparison between the no-vehicle reference signature and the current signature to determine the object presence status, effectively filtering stable states similar to the no-vehicle reference signature, ensuring that only when an object enters the parking space 12 is the subsequent parking confirmation process 208 triggered. If no object enters the parking space 12, the radar sensor 10 enters sleep mode to achieve power-saving purposes.

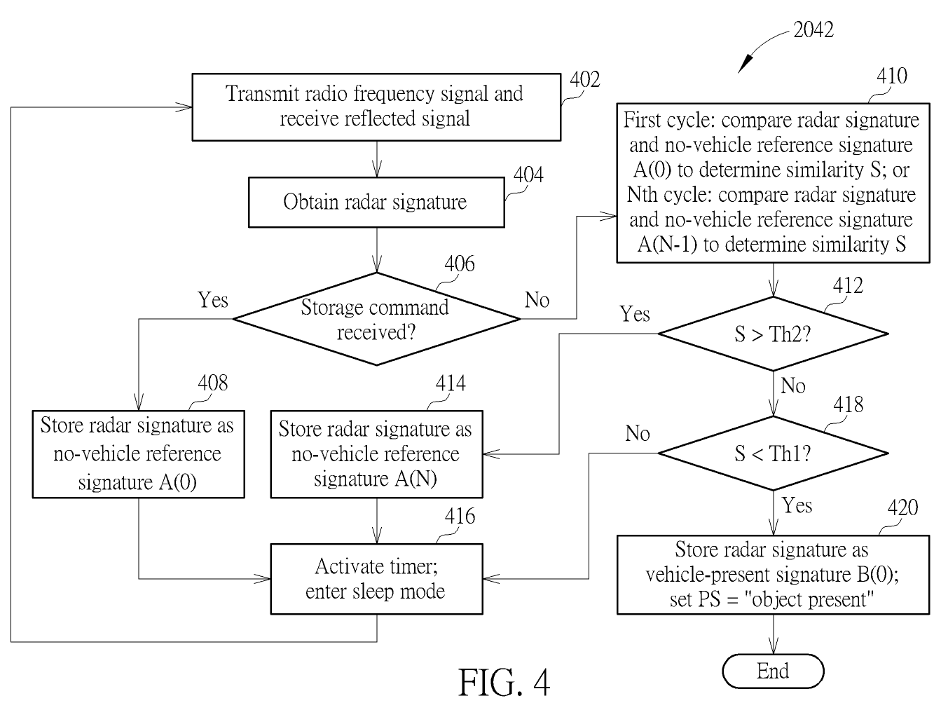

FIG. 4 is a flowchart of another object presence process 2042. The process 2042 is another embodiment of step 204 of FIG. 2. The process 2042 includes steps 402 to 420 for periodically updating the no-vehicle reference signature and monitoring whether an object has entered the parking space 12. The object presence process 2042 of FIG. 4 is suitable for application scenarios where environmental temperature gradually changes. Any reasonable technical modifications or step adjustments fall within the scope disclosed by the present invention. The detailed contents of steps 402 to 420 are described as follows:

Step 402: The analog signal unit 102 and the antenna 108 transmit a radio frequency signal and receive a reflected signal;

Step 404: The digital signal unit 104 obtains a radar signature;

Step 406: The radar sensor 10 determines whether a storage command has been received? If yes, continue to step 408; if no, continue to step 410;

Step 408: The memory 106 stores the radar signature as a no-vehicle reference signature A(0); continue to step 416;

Step 410: In a first cycle, the digital signal unit 104 compares the radar signature with the no-vehicle reference signature A(0) to determine a similarity S; or in an Nth cycle, the digital signal unit 104 compares the radar signature with a no-vehicle reference signature A(N-1) to determine the similarity S;

Step 412: The digital signal unit 104 determines whether the similarity S is greater than a threshold Th2? If yes, continue to step 414; if no, continue to step 418;

Step 414: The memory 106 stores the radar signature as a no-vehicle reference signature A(N); continue to step 416;

Step 416: The radar sensor 10 activates the timer 110 and enters sleep mode; return to step 402;

Step 418: The digital signal unit 104 determines whether the similarity S is less than a threshold Th1? If yes, continue to step 420; if no, continue to step 416;

Step 420: The memory 106 stores the radar signature as a vehicle-present signature B(0), and the radar sensor 10 sets and reports the status PS of the parking space 12 as "object present"; end the object presence process 2042.

Steps 402, 404, 406, 408, 416, 418, and 420 may be respectively similar to steps 302, 304, 306, 308, 314, 312, and 316, and their descriptions may refer to the FIG. 3 embodiment and will not be repeated here. The following provides detailed explanations for steps 410 to 414.

The FIG. 4 embodiment introduces a periodic update mechanism for the no-vehicle reference signature and uses the updated no-vehicle reference signature to compare with the current radar signature, thereby incorporating environmental changes, particularly the influence of temperature changes on radar circuit characteristics, into the comparison considerations. In some applications, temperature changes will cause the no-vehicle reference signature to differ over time (such as A(0) and A(N)), and if the temperature difference is too large, it may lead to misjudgment. For example, a no-vehicle reference signature at 25 degrees will differ greatly from a no-vehicle reference signature at 60 degrees. Therefore, timely updating the no-vehicle reference signature A(N) is crucial for maintaining judgment accuracy. In some embodiments, the parking system 1 will be shut down during fixed periods (such as 0:00 AM to 6:00 AM) and activated during other periods (such as 6:00 AM to 0:00 AM). After activation, the radar sensor 10 will operate within a certain temperature range (for example, 0 to 80°C) due to environmental temperature and circuit heat dissipation effects. Because the voltage, current, and other performance of electronic circuits change with temperature, leading to subtle differences in the radar frequency spectrum, the FIG. 4 embodiment continuously updates the no-vehicle reference signature through steps 410 to 414 to ensure the timeliness and accuracy of the comparison baseline. The FIG. 4 embodiment uses a threshold Th2 to determine whether to update the no-vehicle reference signature A(N) and a threshold Th1 to determine whether an object is detected, where the threshold Th2 may be greater than the threshold Th1. For example, the threshold Th2 may be 95%, and the threshold Th1 may be 80%.

In step 410, in the first cycle of process 2042 after power-on, the digital signal unit 104 loads the no-vehicle reference signature A(0) from the memory 106 and compares the current radar signature with the initial no-vehicle reference signature A(0) to determine the similarity S; whereas in the Nth cycle of process 2042, the digital signal unit 104 loads the no-vehicle reference signature A(N-1) from the memory 106 and compares the current radar signature with the previous cycle's no-vehicle reference signature A(N-1) to determine the similarity S, where N is a positive integer greater than 1, and the Nth cycle and the (N-1)th cycle may be separated by a fixed period (such as 5 minutes). The digital signal unit 104 ensures the timeliness of the similarity comparison baseline by using the updated previous cycle's no-vehicle reference signature A(N-1).

In step 412, the digital signal unit 104 determines whether the similarity S is greater than the threshold Th2 to decide whether the no-vehicle reference signature needs to be updated. The threshold Th2 may be set to a relatively high value (such as 95%). When the similarity S is greater than the threshold Th2, indicating that the current radar signature is highly similar to the previous cycle's no-vehicle reference signature A(N-1) but requires entering step 414 to update the no-vehicle reference signature A(N) to maintain comparison accuracy due to environmental changes (such as temperature drift); when the similarity S is not greater than the threshold Th2, indicating that the current radar signature differs significantly from the no-vehicle reference signature, the no-vehicle reference signature does not need to be updated, and step 418 is entered to perform object presence determination.

In step 414, the memory 106 stores the current radar signature as a new no-vehicle reference signature A(N), replacing the previous cycle's no-vehicle reference signature A(N-1). In some embodiments, the memory 106 may remove the previous cycle's no-vehicle reference signature A(N-1) after storing the new no-vehicle reference signature A(N). The digital signal unit 104 dynamically updates the no-vehicle reference signature A(N) to ensure that the no-vehicle reference signature A(N) can reflect current environmental conditions, particularly radar circuit characteristic drift caused by temperature changes. The updated no-vehicle reference signature A(N) will serve as the comparison baseline in the next cycle of process 2042, enabling the radar sensor 10 to continuously adapt to environmental changes while maintaining judgment accuracy.

The radar sensor 10 uses thresholds Th2 and Th1 to respectively determine whether to update the no-vehicle reference signature and determine whether a vehicle is present. If the similarity S between the current radar signature and the previous cycle's no-vehicle reference signature A(N-1) is above the threshold Th2, the no-vehicle reference signature A(N) is updated; if the similarity S is below the threshold Th1, a vehicle is determined to be present. If the similarity S is between the thresholds Th2 and Th1 (for example, 90%), the radar sensor 10 will neither update the no-vehicle reference signature A(N) nor determine that a vehicle is present, but will continue to use the previous cycle's no-vehicle reference signature A(N-1) and determine no vehicle is present, to avoid misjudgment.

In some embodiments, if the radar sensor 10 is equipped with a temperature sensor 112, the no-vehicle reference signature update in step 414 may incorporate temperature information. In step 404, when the digital signal unit 104 obtains the current radar signature, the temperature sensor 112 may simultaneously detect the current temperature. In step 414, the memory 106 records the current temperature to a corresponding candidate temperature interval among a plurality of candidate temperature intervals (such as each 5-degree Celsius temperature as one interval, covering a 0-80 degree Celsius temperature range, for a total of 16 intervals), and records the current radar signature as a candidate no-vehicle reference signature A(0) corresponding to that candidate temperature interval.

When the radar sensor 10 reboots, the temperature sensor 112 detects a boot-up temperature; the digital signal unit 104 searches for a corresponding candidate temperature interval in the memory 106 based on the boot-up temperature; if a candidate no-vehicle reference signature A(0) corresponding to the candidate temperature interval corresponding to the boot-up temperature exists, the corresponding candidate no-vehicle reference signature A(0) is used for the first cycle comparison in step 410, avoiding misjudgment caused by temperature differences. The no-vehicle reference signature update mechanism incorporating temperature information can resolve judgment errors caused by differences between installation temperature (such as 0 degrees in winter) and actual usage temperature (such as 30 degrees in summer). For example, the memory 106 may record 16 candidate no-vehicle reference signatures A(0) for 16 intervals covering 0 to 80 degrees. For example, if the boot-up temperature is 32 degrees, the digital signal unit 104 may search for the corresponding candidate temperature interval 30 to 35 degrees, the digital signal unit 104 can load the candidate no-vehicle reference signature A(0) corresponding to the candidate temperature interval 30 to 35 degrees for the first cycle comparison in step 410.

In other embodiments, if the radar sensor 10 is not equipped with a temperature sensor 112, the radar sensor 10 may periodically update the no-vehicle reference signature A(N) based on time intervals and estimate temperature changes through digital compensation algorithms. Digital compensation methods may estimate temperature based on component characteristic changes in the radar frequency spectrum, and although accuracy is limited (such as each 10-15 degrees as one interval), they can still provide basic temperature compensation capability.

The object presence process 2042 in FIG. 4 employs a dual-threshold mechanism (Th1 and Th2) and continuous updating of the no-vehicle reference signature, enabling automatic adaptation to environmental factors such as temperature changes affecting radar circuit characteristics. The radar sensor 10 maintains judgment accuracy through dynamic updating of the no-vehicle reference signature while retaining the object presence detection function, suitable for applications with large temperature variations or long-term operation.

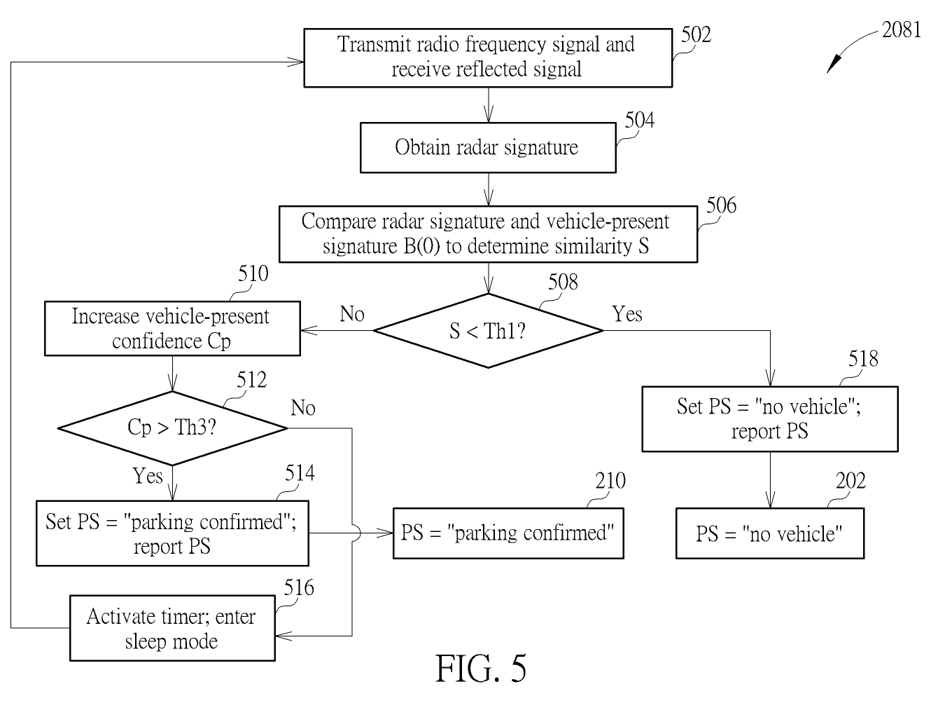

FIG. 5 is a flowchart of a parking confirmation process 2081. The process 2081 is an embodiment of step 208 of FIG. 2. The process 2081 includes steps 502 to 518 for confirming vehicle parking status and excluding false triggers from moving objects. It should be noted that FIG. 5 shows step 518 followed by step 202, which is for convenience in indicating that ending the parking confirmation process 2081 along the path of step 518 returns to step 202 of FIG. 2, that is, following the path marked "failure" after step 208 of FIGS. 2 and 5; shows step 514 followed by step 210, which is for convenience in indicating that ending the parking confirmation process 2081 along the path of step 514 returns to step 210 of FIG. 2, that is, following the path marked "pass" after step 208 of FIG. 2. Any reasonable technical modifications or step adjustments fall within the scope disclosed by the present invention. The detailed contents of steps 502 to 518 are described as follows:

Step 502: The analog signal unit 102 and the antenna 108 transmit a radio frequency signal and receive a reflected signal;

Step 504: The digital signal unit 104 obtains a radar signature;

Step 506: The digital signal unit 104 compares the radar signature with a vehicle-present signature to determine a similarity S;

Step 508: The digital signal unit 104 determines whether the similarity S is less than a threshold Th1? If yes, continue to step 518; if no, continue to step 510;

Step 510: Increase a vehicle-present confidence Cp;

Step 512: The digital signal unit 104 determines whether the vehicle-present confidence Cp is greater than a threshold Th3? If yes, continue to step 514; if no, continue to step 516;

Step 514: The radar sensor 10 sets and reports the status PS of the parking space 12 as "parking confirmed"; end the parking confirmation process 2081.

Step 516: The radar sensor 10 activates the timer 110 and enters sleep mode; return to step 502;

Step 518: The radar sensor 10 sets and reports the status PS of the parking space 12 as "no vehicle"; end the parking confirmation process 2081.

Steps 502 and 504 are basic radar detection processes, and their descriptions are similar to steps 302 and 304 of FIG. 3 and will not be repeated here.

In the first cycle of the parking confirmation process 2081, the vehicle-present confidence Cp may be a preset value (for example, 0). Steps 506 and 508 are used to determine the similarity S between the current radar signature and the vehicle-present signature B(0), thereby setting the vehicle-present confidence Cp based on the similarity S. In step 506, the digital signal unit 104 compares the currently obtained radar signature with the vehicle-present signature B(0) previously stored in the object presence process 2041 of FIG. 3 or the object presence process 2042 of FIG. 4, and calculates the similarity S between the two. In step 508, the digital signal unit 104 determines whether the similarity S is less than the threshold Th1, thereby determining whether the current radar signature and the vehicle-present signature B(0) are similar, and further confirming the stable presence of the object. If the similarity S is not less than the threshold Th1, that is, the similarity S is greater than or equal to the threshold Th1, indicating that the current radar signature is similar to the vehicle-present signature B(0), the probability that the object is a vehicle parked in the parking space 12 increases, so the digital signal unit 104 executes step 510 to increase the vehicle-present confidence Cp; if the similarity S is less than the threshold Th1, indicating that the current radar signature is dissimilar to the vehicle-present signature B(0), the object may be a misjudgment or has departed, so the digital signal unit 104 may reset the vehicle-present confidence Cp and execute step 518 to determine a no-vehicle status. The threshold Th1 used in the parking confirmation process 2081 may be the same as or different from the threshold Th1 used in the object presence process 2041 of FIG. 3 and the object presence process 2042 of FIG. 4.

Steps 510 to 514 are used to determine the status PS of the parking space 12 based on the vehicle-present confidence Cp. In step 510, the digital signal unit 104 increases the vehicle-present confidence Cp to accumulate evidence of stable object presence. The vehicle-present confidence Cp may be generated by a counter, which increments the vehicle-present confidence Cp each time the current radar signature is similar to the vehicle-present signature B(0). This mechanism is used to filter short-term moving object interference, ensuring that only persistently stable objects are confirmed as parked vehicles. In step 512, the digital signal unit 104 determines whether the vehicle-present confidence Cp is greater than the threshold Th3, thereby deciding whether to confirm vehicle parking. If the vehicle-present confidence Cp is greater than the threshold Th3, indicating that the object has been stably present for sufficient time, the digital signal unit 104 executes step 514 to confirm that a vehicle is parked in the parking space 12; if the vehicle-present confidence Cp is not greater than the threshold Th3, indicating that more observation time is needed, the digital signal unit 104 executes step 516 to continue monitoring. In step 514, because the vehicle-present confidence Cp has reached the threshold Th3, the radar sensor 10 sets the status PS of the parking space 12 to "parking confirmed" and reports this status to the parking monitoring device 14. The status PS of "parking confirmed" indicates that a vehicle is indeed stably parked in the parking space 12, triggering the parking monitoring device 14 to execute parking management functions such as billing. After step 514, the parking confirmation process 2081 ends, and the radar sensor 10 will transition to the status PS of "parking confirmed" in step 210 of FIG. 2.

In step 516, because the vehicle-present confidence Cp has not yet reached the confirmation standard, the radar sensor 10 activates the timer 110 and enters sleep mode to achieve power-saving purposes. The timer 110 will wake up the radar sensor 10 after a preset time and return to step 502 to continue the parking confirmation cycle, continuously accumulating the vehicle-present confidence Cp until it reaches the confirmation threshold Th3.

In step 518, because the current radar signature is dissimilar to the vehicle-present signature B(0), indicating possible misjudgment or that the moving object has departed, the radar sensor 10 sets the status PS of the parking space 12 to "no vehicle" and reports this status to the parking monitoring device 14. After step 518, the parking confirmation process 2081 ends, and the radar sensor 10 will return to the no-vehicle status in step 202 of FIG. 2 to restart the monitoring cycle.

The parking confirmation process 2081 in FIG. 5 employs a vehicle-present confidence accumulation mechanism, establishing vehicle-present confidence through continuous comparison with the vehicle-present signature, and effectively filters moving object interference and confirms stable vehicle parking based on the vehicle-present confidence. The radar sensor 10 avoids misjudgment caused by short-term signature changes through confidence accumulation while having a fault-tolerant mechanism for returning to the no-vehicle status, suitable for applications requiring high-accuracy parking confirmation.

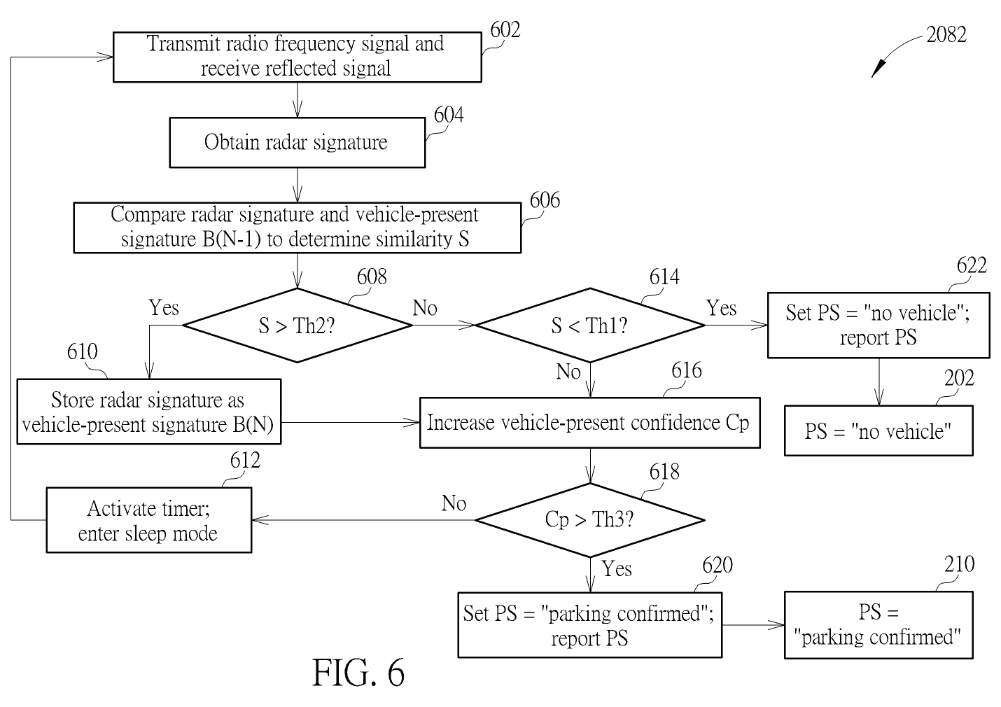

FIG. 6 is a flowchart of another parking confirmation process 2082. The process 2082 is another embodiment of step 208 of FIG. 2. The process 2082 includes steps 602 to 622 for periodically updating the vehicle-present signature, confirming vehicle parking status, and excluding false triggers from moving objects. It should be noted that FIG. 6 shows step 622 followed by step 202, which is for convenience in indicating that ending the parking confirmation process 2082 along the path of step 622 returns to step 202 of FIG. 2, that is, following the path marked "failure" after step 208 of FIGS. 2 and 6; shows step 620 followed by step 210, which is for convenience in indicating that ending the parking confirmation process 2082 along the path of step 620 returns to step 210 of FIG. 2, that is, following the path marked "pass" after step 208 of FIG. 2. Any reasonable technical modifications or step adjustments fall within the scope disclosed by the present invention. The detailed contents of steps 602 to 622 are described as follows:

Step 602: The analog signal unit 102 and the antenna 108 transmit a radio frequency signal and receive a reflected signal;

Step 604: The digital signal unit 104 obtains a radar signature;

Step 606: The digital signal unit 104 compares the radar signature with a vehicle-present signature to determine a similarity S;

Step 608: The digital signal unit 104 determines whether the similarity S is greater than a threshold Th2? If yes, continue to step 610; if no, continue to step 614;

Step 610: The memory 106 stores the radar signature as a vehicle-present signature B(N); continue to step 616;

Step 612: The radar sensor 10 activates the timer 110 and enters sleep mode; return to step 602;

Step 614: The digital signal unit 104 determines whether the similarity S is less than a threshold Th1? If yes, continue to step 622; if no, continue to step 616;

Step 616: Increase a vehicle-present confidence Cp;

Step 618: The digital signal unit 104 determines whether the vehicle-present confidence Cp is greater than a threshold Th3? If yes, continue to step 620; if no, continue to step 612;

Step 620: The radar sensor 10 sets and reports the status PS of the parking space 12 as "parking confirmed"; end the parking confirmation process 2082.

Step 622: The radar sensor 10 sets and reports the status PS of the parking space 12 as "no vehicle"; end the parking confirmation process 2082.

Steps 602, 604, 614, 616, 618, 620, 622, and 612 may be respectively similar to steps 502, 504, 508, 510, 512, 514, 518, and 516 in FIG. 5, and their descriptions may refer to the FIG. 5 embodiment and will not be repeated here. The following provides detailed explanations for steps 606, 608, and 610.

The FIG. 6 embodiment introduces a periodic update mechanism for the vehicle-present signature and uses the updated vehicle-present signature to compare with the current radar signature, thereby incorporating environmental changes, particularly the influence of temperature changes on radar circuit characteristics, into the comparison considerations. In some applications, temperature changes will cause the vehicle-present signature to differ over time (such as B(0) and B(N)), and if the temperature difference is too large, it may lead to misjudgment. For example, a vehicle-present signature at 25 degrees will differ greatly from a vehicle-present signature at 60 degrees. Therefore, timely updating the vehicle-present signature B(N) is crucial for maintaining judgment accuracy. FIG. 6 continuously updates the vehicle-present signature through steps 606 to 610 to ensure the timeliness and accuracy of the comparison baseline. The FIG. 6 embodiment uses a threshold Th2 to determine whether to update the vehicle-present signature B(N) and a threshold Th1 to determine object stability, where the threshold Th2 may be greater than the threshold Th1. For example, the threshold Th2 may be 95%, and the threshold Th1 may be 80%. The threshold Th1 in FIGS. 6 and 4 may be the same or different, and the threshold Th2 may also be the same or different.

In step 606, in the first cycle of process 2082, the digital signal unit 104 loads the vehicle-present signature B(0) from the memory 106 and compares the current radar signature with the initial vehicle-present signature B(0) to determine the similarity S; whereas in the Nth cycle of process 2082, the digital signal unit 104 loads the vehicle-present signature B(N-1) from the memory 106 and compares the current radar signature with the previous cycle's vehicle-present signature B(N-1) to determine the similarity S, where N is a positive integer greater than 1, and the Nth cycle and the (N-1)th cycle may be separated by a fixed period (such as 5 minutes). The digital signal unit 104 ensures the timeliness of the similarity comparison baseline by using the updated previous cycle's vehicle-present signature B(N-1).

In step 608, the digital signal unit 104 determines whether the similarity S is greater than the threshold Th2 to decide whether the vehicle-present signature needs to be updated. The threshold Th2 may be set to a relatively high value (such as 95%). When the similarity S is greater than the threshold Th2, indicating that the current radar signature is highly similar to the previous cycle's vehicle-present signature B(N-1) but requires entering step 610 to update the vehicle-present signature B(N) to maintain comparison accuracy due to environmental changes (such as temperature drift or slight vehicle movement); when the similarity S is not greater than the threshold Th2, indicating that the current radar signature differs significantly from the vehicle-present signature B(N-1), the vehicle-present signature does not need to be updated, and step 614 is entered to perform object stability determination.

In step 610, the memory 106 stores the current radar signature as a new vehicle-present signature B(N), replacing the previous cycle's vehicle-present signature B(N-1). In some embodiments, the memory 106 may remove the previous cycle's vehicle-present signature B(N-1) after storing the new vehicle-present signature B(N). The digital signal unit 104 dynamically updates the vehicle-present signature B(N) to ensure that the vehicle-present signature B(N) can reflect the current vehicle status, particularly adapting to slight position adjustments of the vehicle during parking or signature drift caused by environmental changes. The updated vehicle-present signature B(N) will serve as the baseline for the next cycle's comparison, enabling the radar sensor 10 to continuously adapt to environmental changes while maintaining judgment accuracy.

The radar sensor 10 uses thresholds Th2 and Th1 to respectively determine whether to update the vehicle-present signature and determine object stability. If the similarity S between the current radar signature and the previous cycle's vehicle-present signature B(N-1) is above the threshold Th2, the vehicle-present signature B(N) is updated; if the similarity S is below the threshold Th1, no vehicle is determined. If the similarity S is between the thresholds Th2 and Th1 (for example, 90%), the radar sensor 10 will neither update the vehicle-present signature B(N) nor determine no vehicle, but will continue to use the previous cycle's vehicle-present signature B(N-1) and increase the vehicle-present confidence Cp to avoid misjudgment. Additionally, because the threshold Th2 is set to be greater than the threshold Th1, when entering step 610 after the current radar signature and vehicle-present signature B(N-1) are determined to have high similarity through step 608, this indicates that the similarity S is also definitely greater than the threshold Th1, so that after step 610, step 616 will be performed to increase the vehicle-present confidence Cp.

Compared with the FIG. 5 embodiment, the FIG. 6 embodiment adds a dynamic vehicle-present signature update function. After a vehicle is parked, there may be radar signature changes due to door opening and closing, passenger boarding and alighting, natural vehicle settling, or temperature changes affecting radar characteristics. Through the update mechanism of steps 608 to 610, the radar sensor 10 can adapt to these normal signature changes, avoiding misjudgment of vehicle status PS due to minor changes.

The parking confirmation process 2082 in FIG. 6 employs a dual-threshold mechanism (Th1 and Th2) combined with dynamic vehicle-present signature update technology, enabling automatic adaptation to signature changes during the vehicle parking process. The radar sensor 10 maintains the judgment accuracy of vehicle-present confidence through dynamic updating of the vehicle-present signature.

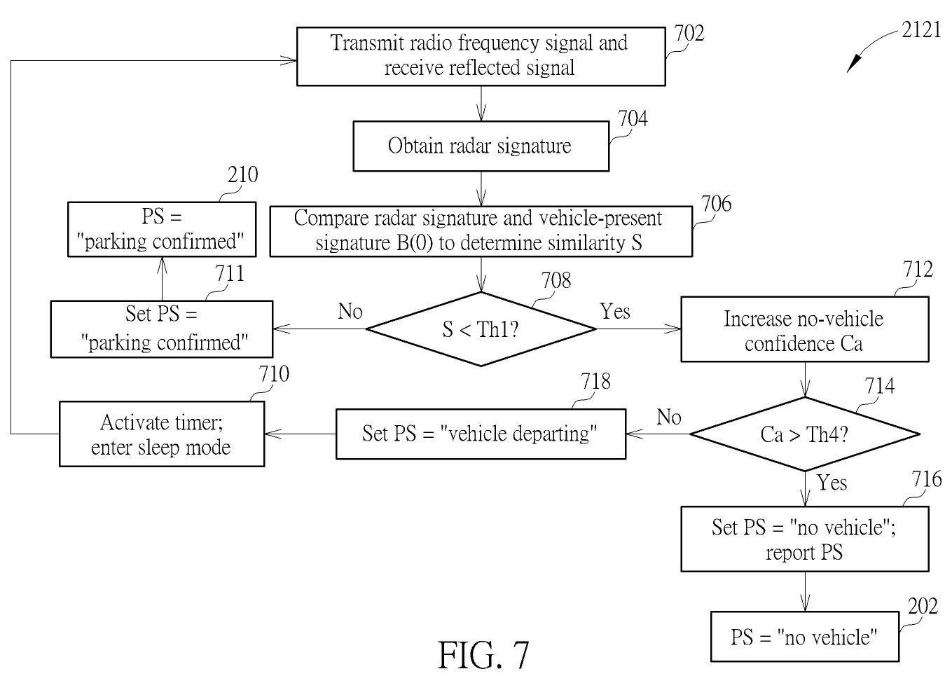

FIG. 7 is a flowchart of a vehicle departure process 2121. The process 2121 is an embodiment of step 212 of FIG. 2. The process 2121 includes steps 702 to 718 for determining that a vehicle has indeed departed from the parking space 12 and excluding false triggers from moving objects. It should be noted that FIG. 7 shows step 716 followed by step 202, which is for convenience in indicating that ending the parking confirmation process 2121 along the path of step 716 returns to step 202 of FIG. 2, that is, following the path marked "pass" after step 212 of FIGS. 2 and 7; shows step 711 followed by step 210, which is for convenience in indicating that ending the parking confirmation process 2121 along the path of step 711 returns to step 210 of FIG. 2, that is, following the path marked "failure" after step 212 of FIG. 2. Any reasonable technical modifications or step adjustments fall within the scope disclosed by the present invention. The detailed contents of steps 702 to 718 are described as follows:

Step 702: The analog signal unit 102 and the antenna 108 transmit a radio frequency signal and receive a reflected signal;

Step 704: The digital signal unit 104 obtains a radar signature;

Step 706: The digital signal unit 104 compares the radar signature with a vehicle-present signature to determine a similarity S;

Step 708: The digital signal unit 104 determines whether the similarity S is less than a threshold Th1? If yes, continue to step 712; if no, continue to step 711;

Step 710: The radar sensor 10 activates the timer 110 and enters sleep mode; return to step 702;

Step 711: The radar sensor 10 sets the status PS of the parking space 12 to "parking confirmed"; end the vehicle departure process 2121.

Step 712: Increase a no-vehicle confidence Ca;

Step 714: The digital signal unit 104 determines whether the no-vehicle confidence Ca is greater than a threshold Th4? If yes, continue to step 716; if no, continue to step 718;

Step 716: The radar sensor 10 sets and reports the status PS of the parking space 12 as "no vehicle"; end the vehicle departure process 2121.

Step 718: The radar sensor 10 sets the status PS of the parking space 12 to "vehicle departing"; continue to step 710.

Steps 702 and 704 are basic radar detection processes, and their descriptions are similar to steps 302 and 304 of FIG. 3 and will not be repeated here.

In the first cycle of the vehicle departure process 2121, the no-vehicle confidence Ca may be a preset value (for example, 0). Steps 706 and 708 are used to determine the similarity S between the current radar signature and the vehicle-present signature B(0) to set the no-vehicle confidence Ca. In step 706, the digital signal unit 104 compares the currently obtained radar signature with the vehicle-present signature B(0) previously stored in the parking confirmation process 2081 of FIG. 5 or the dynamically updated vehicle-present signature B(N) in the parking confirmation process 2082 of FIG. 6, and calculates the similarity S between the two. In step 708, the digital signal unit 104 determines whether the similarity S is less than the threshold Th1, thereby determining whether the current radar signature and the vehicle-present signature B(0) are similar, and further confirming whether the vehicle is still parked. If the similarity S is greater than or equal to the threshold Th1, indicating that the current radar signature is similar to the vehicle-present signature B(0), the vehicle is still parked in the parking space 12, so the radar sensor 10 executes step 711 to set the parking status PS to "parking confirmed." If the similarity S is less than the threshold Th1, indicating that the current radar signature is dissimilar to the vehicle-present signature B(0), the vehicle may have departed from the parking space 12, so the digital signal unit 104 executes step 712 to activate the no-vehicle confidence mechanism to further confirm whether the vehicle has indeed departed. The threshold Th1 used in the vehicle departure process 2121 may be the same as or different from the threshold Th1 used in the object presence process 2041 of FIG. 3, the object presence process 2042 of FIG. 4, the parking confirmation process 2081 of FIG. 5, and the parking confirmation process 2082 of FIG. 6.

In step 712, the no-vehicle confidence Ca is increased. The aforementioned similarity S being less than the threshold Th1 indicates that a change in the vehicle-present signature has been detected, and the vehicle may be departing or has departed, so the no-vehicle confidence mechanism is activated to begin accumulating the no-vehicle confidence Ca. The no-vehicle confidence mechanism can handle moving object interference during the vehicle departure process, avoiding erroneous determination of vehicle status due to short-term interference. The no-vehicle confidence Ca may be generated by a counter, which increments the no-vehicle confidence Ca each time the current radar signature is dissimilar to the vehicle-present signature B(0). The no-vehicle confidence mechanism can filter short-term moving object interference (such as pedestrians passing by the vehicle), ensuring that only when the vehicle truly departs is it confirmed as a no-vehicle status.

Steps 714 and 716 are used to determine the final status PS of the parking space 12 based on the no-vehicle confidence Ca. In step 714, the digital signal unit 104 determines whether the no-vehicle confidence Ca is greater than the threshold Th4, thereby deciding whether to confirm vehicle departure. If the no-vehicle confidence Ca is greater than the threshold Th4, indicating that the evidence of vehicle departure is sufficient, the digital signal unit 104 executes step 716 to confirm that the vehicle has departed from the parking space 12, determining that no vehicle is parked in the parking space; if the no-vehicle confidence Ca is not greater than the threshold Th4, indicating that more observation time is needed, the radar sensor 10 executes step 718 to set the parking status PS to "vehicle departing," indicating that the parking status PS is experiencing a period of higher uncertainty, and then executes step 710 to continue monitoring.

In step 716, because the no-vehicle confidence Ca has reached the threshold Th4, the radar sensor 10 sets the status PS of the parking space 12 to "no vehicle" and reports this status to the parking monitoring device 14. The status PS of "no vehicle" indicates that the vehicle has indeed departed from the parking space 12, and the parking monitoring device 14 can stop billing and open the parking space for use by other vehicles. After step 716, the vehicle departure process 2121 ends, and the radar sensor 10 will return to the no-vehicle status in step 202 of FIG. 2 to restart the monitoring cycle.

In step 711, because the current radar signature is similar to the vehicle-present signature B(0), indicating that the vehicle is still parked in the parking space 12, the radar sensor 10 maintains the parking status PS as "parking confirmed." After step 711, the vehicle departure process 2121 ends, and the radar sensor 10 will transition to the status PS of "parking confirmed" in step 210 of FIG. 2.

In step 718, because the no-vehicle confidence Ca is not greater than the threshold Th4, the radar sensor 10 sets the status PS of the parking space 12 to "vehicle departing" and reports this status to the parking monitoring device 14. The status PS of "vehicle departing" indicates that the vehicle may be departing from the parking space 12, but it cannot yet be determined whether the vehicle has indeed completely departed from the parking space 12, or it may only be a phenomenon caused by moving object interference, so monitoring needs to continue to obtain further results, and therefore step 710 will be performed after step 718. In step 710, the radar sensor 10 activates the timer 110 and enters sleep mode to achieve power-saving purposes. The timer 110 will wake up the radar sensor 10 after a preset time and return to step 702 to continue the vehicle departure monitoring cycle. This design ensures that the system can continuously monitor vehicle status until the vehicle indeed departs.

The vehicle departure process 2121 is specifically designed to handle moving object interference during vehicle parking. When pedestrians, animals, or other moving objects pass near a parked vehicle, they may temporarily change the radar signature, causing the similarity with the vehicle-present signature B(0) to decrease. Through the "vehicle departing" transient status in step 712 and the no-vehicle confidence Ca accumulation mechanism, the system can distinguish between actual vehicle departure and short-term moving object interference, avoiding erroneous determination of vehicle departure due to temporary interference. The vehicle departure process 2121 in FIG. 7 employs a phased vehicle departure determination mechanism, effectively filtering moving object interference and confirming that the vehicle has indeed departed through the "vehicle departing" transient status and no-vehicle confidence accumulation technology. The radar sensor 10 avoids misjudgment caused by short-term signature changes through confidence accumulation, ensuring the accuracy and reliability of vehicle departure determination, suitable for parking management applications requiring precise monitoring of vehicle departure status.

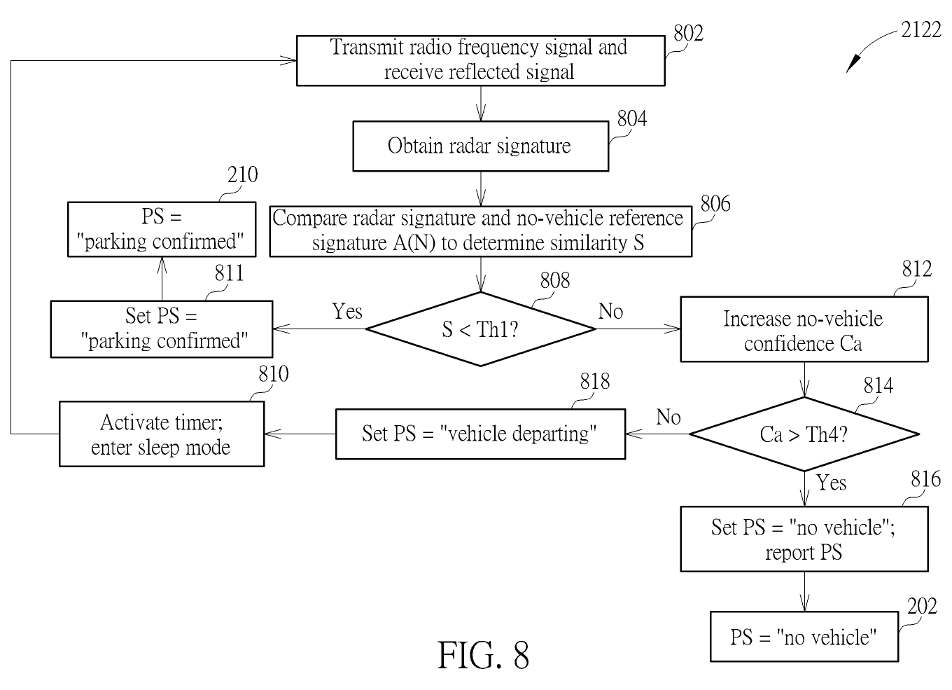

FIG. 8 is a flowchart of another vehicle departure process 2122. The process 2122 is another embodiment of step 212 of FIG. 2. The process 2122 includes steps 802 to 818 for determining that a vehicle has indeed departed from the parking space 12 and excluding false triggers from moving objects. It should be noted that FIG. 8 shows step 816 followed by step 202, which is for convenience in indicating that ending the parking confirmation process 2122 along the path of step 816 returns to step 202 of FIG. 2, that is, following the path marked "pass" after step 212 of FIGS. 2 and 8; shows step 811 followed by step 210, which is for convenience in indicating that ending the parking confirmation process 2122 along the path of step 811 returns to step 210 of FIG. 2, that is, following the path marked "failure" after step 212 of FIG. 2. Any reasonable technical modifications or step adjustments fall within the scope disclosed by the present invention. The detailed contents of steps 802 to 818 are described as follows:

Step 802: The analog signal unit 102 and the antenna 108 transmit a radio frequency signal and receive a reflected signal;

Step 804: The digital signal unit 104 obtains a radar signature;

Step 806: The digital signal unit 104 compares the radar signature with a no-vehicle reference signature to determine a similarity S;

Step 808: The digital signal unit 104 determines whether the similarity S is less than a threshold Th1? If yes, continue to step 811; if no, continue to step 812;

Step 810: The radar sensor 10 activates the timer 110 and enters sleep mode; return to step 802;

Step 811: The radar sensor 10 sets the status PS of the parking space 12 to "parking confirmed"; end the vehicle departure process 2122.

Step 812: Increase a no-vehicle confidence Ca;

Step 814: The digital signal unit 104 determines whether the no-vehicle confidence Ca is greater than a threshold Th4? If yes, continue to step 816; if no, continue to step 818;

Step 816: The radar sensor 10 sets and reports the status PS of the parking space 12 as "no vehicle"; end the vehicle departure process 2122.

Step 818: The radar sensor 10 sets the status PS of the parking space 12 to "vehicle departing"; continue to step 810.

The FIG. 8 embodiment employs a no-vehicle reference signature comparison mechanism, as opposed to the FIG. 7 embodiment's use of vehicle-present signature comparison. Steps 802, 804, 810, 811, 812, 814, 816, and 818 may be respectively similar to steps 702, 704, 710, 711, 712, 714, 716, and 718 in FIG. 7, and their descriptions may refer to the FIG. 7 embodiment and will not be repeated here. The following provides detailed explanations for steps 806 and 808.

In step 806, the digital signal unit 104 compares the currently obtained radar signature with the previously stored no-vehicle reference signature A(0) or dynamically updated no-vehicle reference signature A(N), and calculates the similarity S between the two. The comparison method of step 806 directly determines whether the status PS of the current parking space 12 has returned to the no-vehicle status, providing another vehicle departure detection technique.

In step 808, the digital signal unit 104 determines whether the similarity S is less than the threshold Th1, thereby determining whether the current radar signature and the no-vehicle reference signature are similar, and further confirming whether the status PS of the parking space 12 has returned to the no-vehicle status. If the similarity S is greater than or equal to the threshold Th1, indicating that the current radar signature is similar to the no-vehicle reference signature, the parking space 12 may have returned to the no-vehicle status, so the digital signal unit 104 executes step 812 to enter the vehicle departure processing flow; if the similarity S is less than the threshold Th1, indicating that the current radar signature is dissimilar to the no-vehicle reference signature, the vehicle is still parked in the parking space 12, so the radar sensor 10 executes step 811 to set the parking status PS to "parking confirmed."

The FIG. 8 embodiment employs background signature comparison technology, determining vehicle departure status through direct comparison with the no-vehicle reference signature. The radar sensor 10 can directly determine whether the status PS of the parking space 12 has returned to the initial no-vehicle status, without needing indirect comparison through the vehicle-present signature. In some embodiments, the radar sensor 10 is equipped with a temperature sensor 112 and can use a candidate no-vehicle reference signature corresponding to the current temperature for comparison, ensuring that temperature changes do not affect the accuracy of vehicle departure determination. Specifically, the temperature sensor 112 may detect the boot-up temperature of the radar sensor 10, the digital signal unit 104 searches for a corresponding candidate temperature interval in the memory 106 based on the boot-up temperature, and if a candidate no-vehicle reference signature corresponding to the candidate temperature interval corresponding to the boot-up temperature exists, the corresponding candidate no-vehicle reference signature is used as the no-vehicle reference signature. If no candidate no-vehicle reference signature corresponding to the candidate temperature interval corresponding to the boot-up temperature exists, the digital signal unit 104 uses the radar signature stored when the storage command Cmd was received as the no-vehicle reference signature.

Additionally, because the no-vehicle reference signature includes features of the fixed obstacle 122 in the parking space 12, such as a manhole cover or electrical equipment box, it ensures correct identification of the original empty parking space status after the vehicle departs.

The main difference between the FIG. 8 embodiment and the FIG. 7 embodiment lies in the object of signature comparison and the determination logic. The FIG. 7 embodiment uses the "vehicle-present signature" as the comparison baseline, thereby monitoring the disappearance process of vehicle features. In contrast, the FIG. 8 embodiment uses the "no-vehicle reference signature" as the comparison object, focusing on the recovery of the no-vehicle status.

The vehicle departure process 2122 in FIG. 8 employs a background signature comparison mechanism, determining vehicle departure status through direct comparison with the no-vehicle reference signature, and combines no-vehicle confidence accumulation technology to filter moving object interference. This embodiment provides an alternative technical solution to FIG. 7, particularly suitable for parking management applications requiring direct determination of no-vehicle status recovery or having temperature compensation functionality.

The radar sensor and its operating method in the embodiments of FIGS. 1-8 resolve the fixed obstacle misjudgment problem through the no-vehicle reference signature mechanism, introduce temperature compensation technology, employ dual-threshold determination and candidate temperature interval databases to dynamically adapt to temperature environmental changes, and employ vehicle-present confidence and no-vehicle confidence accumulation mechanisms to filter interference from moving objects, jointly constructing a complete intelligent parking monitoring solution that effectively resolves key problems of traditional technologies such as fixed obstacle misjudgment, moving object interference, and temperature drift, providing an accurate, reliable, and economical technical solution for parking management.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method of operating a radar sensor, comprising:
obtaining a first radar signature at a first time point;
in response to a storage command, storing the first radar signature as a no-vehicle reference signature, wherein the no-vehicle reference signature includes features of a fixed obstacle within a parking space;
obtaining a second radar signature at a second time point;
comparing the second radar signature with the no-vehicle reference signature to determine a first similarity; and
processing the second radar signature based on the first similarity.

2. The method of claim 1, wherein processing the second radar signature based on the first similarity comprises:
discarding the second radar signature if the first similarity is greater than or equal to a first threshold.

3. The method of claim 1, wherein processing the second radar signature based on the first similarity comprises:
storing the second radar signature as a vehicle-present signature if the first similarity is less than a first threshold.

4. The method of claim 1, wherein processing the second radar signature based on the first similarity comprises:
updating the no-vehicle reference signature with the second radar signature if the first similarity is greater than a second threshold.

5. The method of claim 4, wherein updating the no-vehicle reference signature with the second radar signature if the first similarity is greater than the second threshold comprises:
detecting a current temperature at the second time point;
in a memory, recording the current temperature to a corresponding candidate temperature interval of a plurality of candidate temperature intervals, and recording the second radar signature as a candidate no-vehicle reference signature corresponding to the candidate temperature interval.

6. The method of claim 5, further comprising:
when the radar sensor reboots, detecting a boot-up temperature;
finding a corresponding candidate temperature interval in the memory based on the boot-up temperature; and
if a candidate no-vehicle reference signature corresponding to the candidate temperature interval corresponding to the boot-up temperature exists, using the corresponding candidate no-vehicle reference signature as the no-vehicle reference signature.

7. The method of claim 4, wherein processing the second radar signature based on the first similarity further comprises:
storing the second radar signature as a vehicle-present signature if the first similarity is less than a first threshold;
wherein the first threshold is less than the second threshold.

8. The method of claim 7, further comprising:
obtaining a third radar signature at a third time point;
comparing the third radar signature with the second radar signature to determine a second similarity;
setting a vehicle-present confidence based on the second similarity; and
determining a state of the parking space based on the vehicle-present confidence.

9. The method of claim 8, wherein setting the vehicle-present confidence based on the second similarity comprises:
increasing the vehicle-present confidence if the second similarity is greater than or equal to a second threshold.

10. The method of claim 8, wherein determining the state of the parking space based on the vehicle-present confidence comprises:
confirming that a vehicle is parked in the parking space if the vehicle-present confidence is greater than a third threshold.

11. The method of claim 8, further comprising:
obtaining a fourth radar signature at a fourth time point;
comparing the fourth radar signature with the second radar signature to determine a third similarity;
setting a no-vehicle confidence based on the third similarity; and
determining the state of the parking space based on the no-vehicle confidence.

12. The method of claim 11, wherein setting the no-vehicle confidence based on the third similarity comprises:
increasing the no-vehicle confidence if the third similarity is less than a second threshold.

13. The method of claim 11, wherein determining the state of the parking space based on the no-vehicle confidence comprises:
determining that no vehicle is parked in the parking space if the no-vehicle confidence is greater than a third threshold.

14. The method of claim 1, further comprising:
obtaining a fifth radar signature at a fifth time point;
comparing the fifth radar signature with the no-vehicle reference signature to determine a fourth similarity;
setting a no-vehicle confidence based on the fourth similarity; and
determining a state of the parking space based on the no-vehicle confidence.

15. The method of claim 14, wherein setting the no-vehicle confidence based on the fourth similarity comprises:
increasing the no-vehicle confidence if the fourth similarity is greater than a fourth threshold.

16. The method of claim 14, wherein determining the state of the parking space based on the no-vehicle confidence comprises:
determining that no vehicle is parked in the parking space if the no-vehicle confidence is greater than a fifth threshold.

17. The method of claim 14, wherein determining the state of the parking space based on the no-vehicle confidence comprises:
at the fifth time point, detecting a boot-up temperature;
finding a corresponding candidate temperature interval in a memory based on the boot-up temperature;
if a candidate no-vehicle reference signature corresponding to the candidate temperature interval corresponding to the boot-up temperature exists, using the corresponding candidate no-vehicle reference signature as the no-vehicle reference signature.

18. The method of claim 17, further comprising:
if no candidate no-vehicle reference signature corresponding to the candidate temperature interval corresponding to the boot-up temperature exists, using the first radar signature as the no-vehicle reference signature.

19. The method of claim 1, wherein determining the first similarity comprises:
identifying the fixed obstacle features in the first radar signature;
in the first radar signature, defining that the fixed obstacle features are located in a first frequency spectrum range; and
for portions outside the first frequency spectrum range, comparing the second radar signature with the first radar signature to determine the first similarity.

20. A radar sensor, comprising:
an antenna configured to receive an echo signal; and
a processing circuit coupled to the antenna, and configured to obtain a first radar signature based on the echo signal at a first time point, in response to a storage command, store the first radar signature as a no-vehicle reference signature, wherein the no-vehicle reference signature includes features of a fixed obstacle within a parking space, obtain a second radar signature based on the echo signal at a second time point, compare the second radar signature with the no-vehicle reference signature to determine a first similarity, and process the second radar signature based on the first similarity.
